(19) United States
(12) Patent Application Publication
(10) Pub. No.: US 2008/0285577 A1
(43) Pub. Date: Nov. 20, 2008

(54) Systems and Methods for Providing Network-Wide, Traffic-Aware Dynamic Acceleration and Admission Control for Peer-to-Peer Based Services

(76) Inventors: Yehuda Zisapel, Tel Aviv (IL); David Aviv, Tel Aviv (IL)

Correspondence Address: ROTHWELL, FIGG, ERNST & MANBECK, P.C., 1425 K STREET, N.W., SUITE 800, WASHINGTON, DC, 20005, US

(21) Appl. No.: 11/748,678

(22) Filed: May 15, 2007

(51) Int. Cl. H04L 12/56; H04L 12/28

(52) U.S. Cl. 370/409; 370/395.53

(57) ABSTRACT

In one aspect, the invention provides systems and methods for providing users with a peer-to-peer (P2P) acceleration service over any form of broadband access.

### BACKGROUND

1. Field of the Invention

The present invention relates generally to peer-to-peer (P2P) based services, and, in some embodiments, to systems and methods for forming a P2P distribution network and providing users of a network service provider (NSP) with a P2P acceleration service over any form of broadband access. Besides P2P acceleration, embodiments of the invention may be used to distribute efficiently new walled garden (WG) based services, such as video-on-Demand (VoD), thereby enabling new NSP business models. Moreover, by using systems and methods disclosed herein, new quality-of-service (QoS) and admission control (AC) methods may be addressed. Accordingly, major savings can be achieved where the bandwidth and network resources compound annual growth rate (CAGR) is likely to cross the 100% rate.

2. Discussion of the Background

P2P architecture, in contrast to client/server architecture, is a type of network architecture in which each node (i.e., client software) has equivalent capabilities. Often P2P architecture is implemented by giving each node both server and client capabilities. Typically each node is referred to as a “peer.”

In recent usage, P2P has come to describe applications in which users can exchange files with each other over the Internet, either directly or through a mediating server. Popular recent examples of programs for connecting to such file-sharing networks are DC++, Kazaa and WinMX.

P2P is advantageous because it reduces the computing resources and connectivity requirements for the content owners and distributors. Moreover, the traffic model becomes symmetric. Everyone is both a content server and a content downloader, while central servers can be used as central repositories for an efficient lookup providing lists of “who owns what.” It is the nature of P2P to be rate aware so as to utilize the fastest uplinks available. Early signs from the main operating systems vendors indicate that P2P is perceived as the next generation of large content distribution. All major desktop computer vendors have built in P2P functionalities.

Current challenges faced by network service providers originate from the fact that P2P encourages the use of higher broadband speeds, and, in its current form, disrupts the broadband business model and becomes a threat due to the growth of P2P non revenue transit traffic, which traffic growth forces the continuous upgrade of the network resources without providing compensation.

Current methods for Internet traffic admission control are based on edge routers, such as broadband remote access servers (BRAS), which authenticate the remote user and assign to the user an ISP address. This class is known as “static” and provides Internet access service (over first/last mile) and shapes the down-stream traffic (asymmetric traffic web model), but are unable to address the dynamic and symmetric network-wide nature of P2P. Moreover, the entire P2P traffic is routed through the ISP, as shown in FIG. 1.

### SUMMARY

Accordingly, it is one object of the present invention to form a P2P network and provide users with P2P acceleration service over any form of broadband access (e.g., DSL, Cable, Optical, Mobile and Wireless). Another object is to provide a P2P service platform for value added services over P2P (VASoP2P). It is a further object of the present invention to provide a P2P Router for network-wide, traffic-aware and dynamic admission control of P2P traffic. Another object is to use a P2P protocol as one of the main network core protocols. It is still another object to provide a “P2P control plane,” which is preferably complementary to providers who have decided to develop an “Internet Protocol Multimedia Subsystem (IMS) based control plane” or any other control plane.

A P2P acceleration service according to an embodiment of the invention provides a fast Internet based P2P service to users. This service will drastically enhance the user experience as compared to standard P2P. The effect, from the network service provider's point of view, is considered as “cleansing” the network of standard P2P. For this service, in some embodiments, the user must use a P2P client provided by the user's NSP. Upon using this client, the NSP will regulate the network traffic in the most efficient way to meet the user's service level agreement (SLA). The user using that service is aware of being part of file sharing both as a sender (seed) and as a downloader (leech) (for the sake of consistency, we will use the biTorrent P2P terms through out this patent, without losing the generality of using any P2P client). The benefit to the NSP is lowering the off-net traffic (outgoing and incoming traffic), which otherwise may require major upgrades.

A P2P service platform according to an embodiment of the invention enables introduction of new wallet garden P2P based accelerated content distribution services (such as “on demand” streaming distribution services), which could be provided over the broadband infrastructure without the need for new overly complicated control planes and access upgrades. For that service, in some embodiments, the user must use a P2P client as provided by the user's NSP. Upon using this client, the NSP will regulate the network traffic in the most efficient way to meet the user's service level agreement.

In one embodiment, a P2P router for providing the P2P acceleration service and/or service platform is updated by a tracker server with information regarding relevant swarms so that the P2P router may compute quality-of-service and/or access control shaping policies.

The above and other embodiments of the present invention are described below with reference to the accompanying drawings.

### BRIEF DESCRIPTION OF THE DRAWINGS

The accompanying drawings, which are incorporated herein and form part of the specification, illustrate various embodiments of the present invention. In the drawings, like reference numbers indicate identical or functionally similar elements.

FIGS. 1-2 illustrate a conventional NSP network that has a typical walled garden network, but does not have the ability to accelerate P2P traffic.

FIG. 3 illustrates an NSP network according to an embodiment of the invention.

FIG. 4 illustrates an I-PAP that is part of both a public and private swarm.

FIG. 5 illustrates a P2P control plane according to an embodiment of the invention.

FIG. 6 illustrates a P2P data plane according to an embodiment of the invention.

FIG. 7 illustrates an accelerated P2P data flow and a regular P2P data flow.

FIG. 8 illustrates a service platform for value added services (VAS).

FIG. 9 illustrates a content delivery and distribution value chain.

FIG. 10 illustrates a value added services control plane according to an embodiment of the invention.

FIG. 11 illustrates a value added services data plane according to an embodiment of the invention.

FIG. 12 illustrates QoS and AC method.

FIG. 13 illustrates a P2P distribution tree as the basis for the QoS AND AC calculation.

FIG. 14 is a schematic of a P2P router according to an embodiment of the invention. Provided

FIG. 15 Describes the high level P2P acceleration and redirection/forwarding policies according to the embodiment of the invention

FIG. 16 Provides the basic P2P flows detection and redirection/forwarding algorithm

### DETAILED DESCRIPTION OF PREFERRED EMBODIMENTS

As used herein, the words “a” and “an” mean “one or more.”

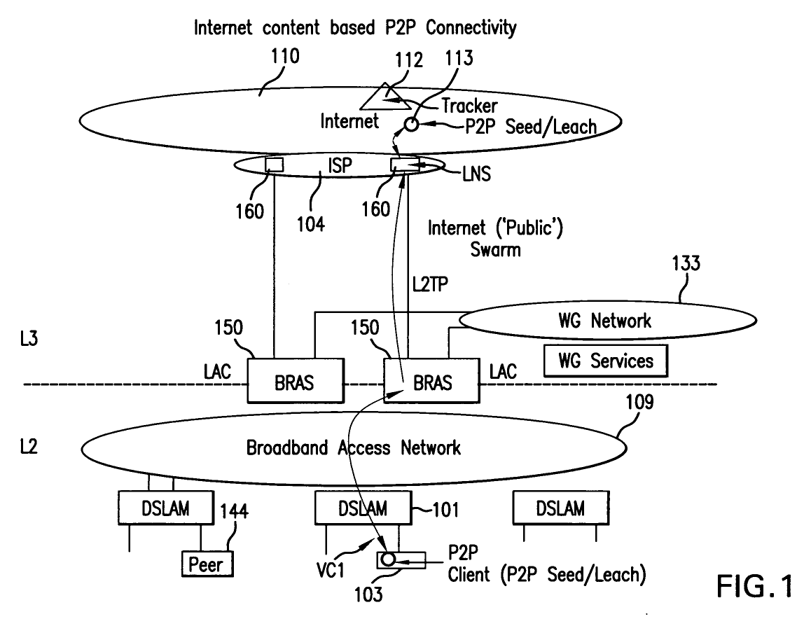

FIG. 1 is an exemplary schematic illustration of a conventional broadband access network 109 provided by a NSP. Broadband access network 109 provides end user nodes (e.g., node 103) with access to the Internet 110. As shown in FIG. 1, edge routers (LAC) 150, which are connected to network 109 and maintained by the NSP, are connected to routers (LNS) 160, which are maintained by an Internet service provider (ISP) 104, and to a walled garden network 133, which is maintained by the NSP. As also shown in FIG. 1, an access node 101 (e.g., a digital subscriber line access multiplexer (DSLAM) or MSAN/G or other access node) provides an interface between the network 109 and end user nodes (e.g., end user node 103).

Each access node 101, typically, is located at an exchange building that provides the interfaces to the copper and fiber cables to user sites. Typically, each access node 101 provides access media gateway functionality for voice, data and video services on the core Internet Protocol (“IP”) based network. A “last mile” virtual connection (“VC”) (e.g., a virtual circuit, virtual local area network (“VLAN”) or other virtual connection) identifier can be provisioned for subscribed users dedicated to Internet based “best effort” or any other purposes. For example, in case of Ethernet VLAN technology being used as the last mile, the identifier may be a VLAN tag.

An ISP 104 manages the standard P2P Internet traffic, wherein admission control is based on edge routers such as broadband access remote server (“BRAS”) (also known as “LNS”), which authenticates the remote user and assigns him a public routable address from the ISP space (e.g., via the PPPoE protocol). In case that the NSP terminates the PPPoE it will be done at the BRAS or at the Layer 2 Access Concentrator (LAC) level. LNS-LAC connectivity is usually maintained over L2TP (Layer 2 Tunneling Protocol) Link. These well known standards are basis for the standard “always-on best-effort” service.

A walled garden (WG) network 133 is also shown in FIG. 1. The NSP provides WG based services via separate connectivity to the WG network 133. That way, the NSP can provide internal value added services to enrolled users. Note that there might be several methods of such connectivity where different BRAS's (LAC's) or different DSLAM trunks might be allocated to WG network 133.

Seeding/leeching content via a remote Internet peer 113 is provided by the means of the swarm controlled by the “tracker” 112 (biTorrent terminology) somewhere in the global Internet space 110, such that NSP user 103 using a typical P2P client is able to maintain P2P connectivity over the Internet. However, this connectivity is based on the best-effort service provided over VC1.

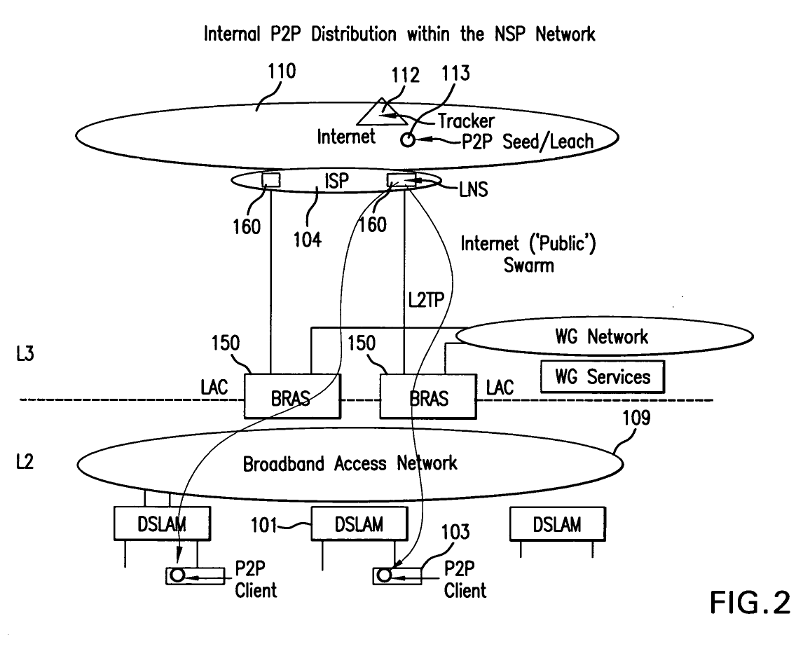

FIG. 2 provides the connectivity description within the NSP network where peers 103, 144 are exchanging information via the LNS which serves as the edge router maintaining the peer's addresses. IP level peers routing visibility exists only at the LNS level. Note that the routing can take place over several ISPs, when the NSP's peers share several ISPs.

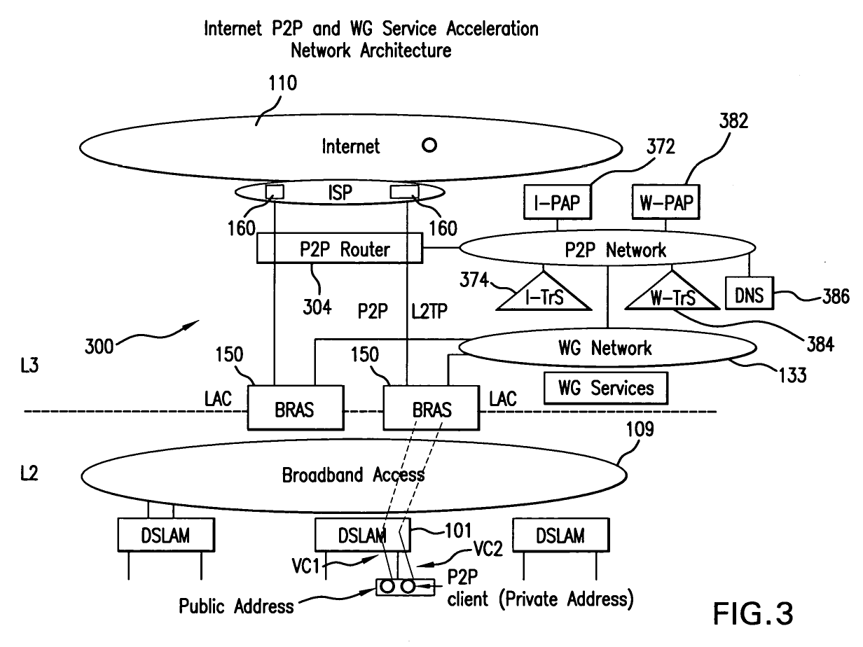

FIG. 3 is a schematic illustration of a NSP network 300 according to an embodiment of the invention.

As illustrated in FIG. 3, NSP user 103, which subscribes to an accelerated P2P services, is connected to access node 101 via a second virtual connection (VC2), which has an end point routing address. This end point routing address is allocated by the NSP (e.g., via standard PPPoE or via DHCP method) such that the routing address on VC2 is allocated from the NSP space (in contrast to the routing address on VC1 which is allocated from the ISP space), without any impact on the current ISP operational model. Thus, the NSP is capable of leveraging VC2 as a tool both for a separate quality-of-service model for accelerating P2P as well as for walled garden based distribution services (note that the P2P service model might form a complementary architecture to the IMS control plane for streaming alike services without the need for network multicast architecture). Without loosing generality, it might be applied to any broadband access network such as cable, wireless and mobile.

As illustrated in FIG. 3, NSP network 300 includes a P2P router 304 to handle the “off-net” traffic, which router 304 is connected between routers 150 and 160. Accordingly, all traffic from node 103 to the Internet (via the proxy I-PAP 372 as explained below) and all traffic from the Internet to node 103 passes through a P2P router 304. In some embodiments, P2P router 304 functions to detect P2P traffic destined for a user enrolled in the acceleration service and route the detected traffic to an assigned P2P pipe (e.g., VC2). In some embodiments, P2P router 304 detects such P2P traffic by parsing, in real-time, incoming packets and/or performing a deep packet inspection (DPI) of the packets that make up the traffic.

In some embodiments, P2P router 304 may also create a P2P control plane over the NSP network 300. The P2P control plane, in some embodiments, provides an automated real time adaptive quality-of-service plane without the need for traffic engineering.

In some embodiments, the access networks' available up/down bandwidth at each peer are automatically taken into consideration by a P2P tracker algorithm (I-TrS) via standard score assigned to each peer. File sharing is done and controlled from the NSP itself via the dedicated P2P pipes, thereby enabling the best quality-of-service available. Note that this provides an alternative adaptive ‘self adjustable’ method to the existing one in which the ISP centrally manage and control the end user via a central edge router (such as a BRAS (LNS)). The P2P traffic managed according to a method of the present invention is completely distributed and managed by the peer clients themselves, thus providing real time adaptive quality-of-service based on the available uplink and downlink bandwidth and score controlled by the swarm tracker (I-TrS).

In some embodiments, the P2P control plane ensures that P2P acceleration starts once the content is resident or partially resident in one of the accelerated P2P peers (i.e., the P2P clients that connect to access network 109 via a P2P pipe as well as all of the I-PAPs 372). Note that until all the content pieces are resident in the NSP, the remaining pieces continue to be imported (e.g., from the Internet). Additionally, behavioral content demand is preferably included in the P2P algorithm in order to have the expected content available locally or at another closed network site ready for use.

As further illustrated in FIG. 3, network 300 includes a P2P acceleration system. P2P acceleration system may include an Internet peer acceleration proxy (I-PAP) 372 and an Internet tracker server (I-TrS) 374. I-PAP 372 serves as a high speed peer (high score seed/leach) to download missing data chunks for NSP users via swarms over the Internet. I-PAP 372 is a member in all the swarms that require missing content data chunks that do not reside in the NSP's peers. I-TrS 374 serves as a tracker server for the NSP's accelerated swarms, managing the accelerated private swarms. I-TrS 374 may be implemented using standard tracker software that can be scaled to support many swarms

In some embodiments, P2P distribution is controlled by the I-TrS and proprietary rights will be checked according to digital rights management (DRM). For those swarms requiring payment, payment verification may be done via the I-TrS server (DRM attributes), and the system will be informed of such.

Besides the novelty of the creation of a P2P pipe and control plane, it is observed that with the same access node and BRAS equipment used, the NSP is capable to provide the acceleration, and any other service that utilizes the P2P protocol.

P2P model may also include a walled garden acceleration system. Walled garden acceleration system may provide value added services over P2P and may include: a walled garden peer acceleration proxy (“W-PAP”) 382, a walled garden tracker server (“W-TrS”) 384, and a domain-name server (“DNS”) 386.

W-PAP 382 is configured to enable downloading of content from content providers to the NSP network (not necessarily using P2P techniques), and format it such that it could be distributed over to end user nodes (e.g., node 103) using a P2P protocol. W-TrS 384 is configured to serve as a tracker server for the walled garden accelerated content. DNS 386 is configured to enable acceleration or downloading of pre-stored content.

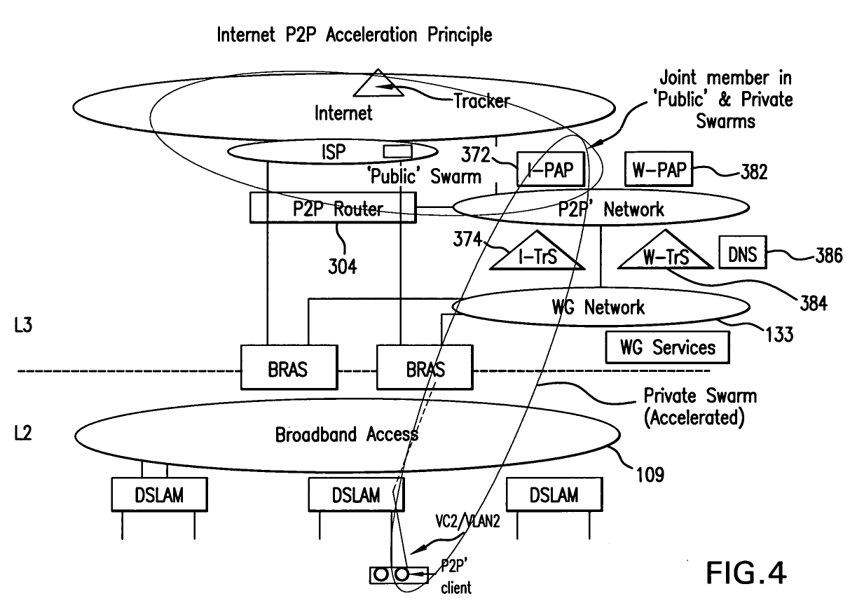

FIG. 4 highlights the relevant components used in a P2P acceleration service according to embodiments of the invention. As illustrated in FIG. 4, I-PAP 372 is configured to be simultaneously a member of swarms over the global Internet (“public swarms”) and swarms controlled by I-TrS 374 (“private swarms”). Because I-PAP 372 is connected to the Internet using high speed connectivity links, any global Internet tracker (e.g., tracker 112) will assign to I-PAP 372 a very high score. Therefore, I-PAP 372 is used to download quickly any missing chunks that are requested by the NSP's users that are using the P2P acceleration service.

As explained above, I-TrS 374 is the NSP's tracker server, which is used to track the private or accelerated swarms over NSP network 300. Because I-PAP 372 is a member of the swarms tracked by I-TrS 374 as well as a member of the public swarms, it is guaranteed that any missing chunk of data for swarms tracked by I-TrS 374 will be downloaded quickly from the Internet by I-PAP 372.

Because P2P acceleration takes place over VC2 (“the P2P pipe”), quality-of-service can be controlled by the NSP. Note also that content acceleration is achieved by downloading from the Internet in a fast way all swarms' missing chunks by I-PAP 372 by using P2P router 304. The address pools allocated to the accelerated peers 103 are controlled by the NSP (assign geographical pools by BRAS/Radius for example), in such a way, the P2P distribution in the NSP network can be controlled by BRAS 150 and not by the ISP's LNS, as is done for the non-accelerated P2P flows.

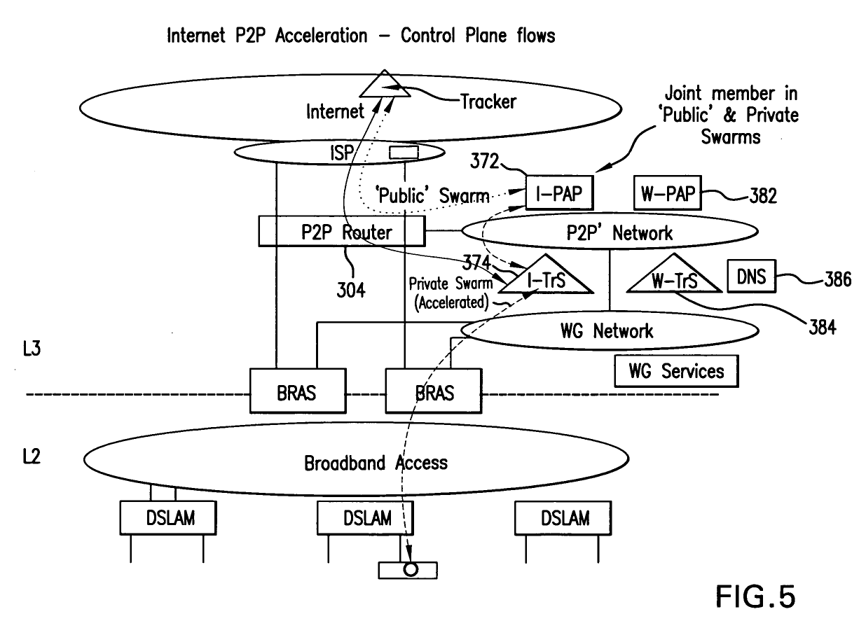

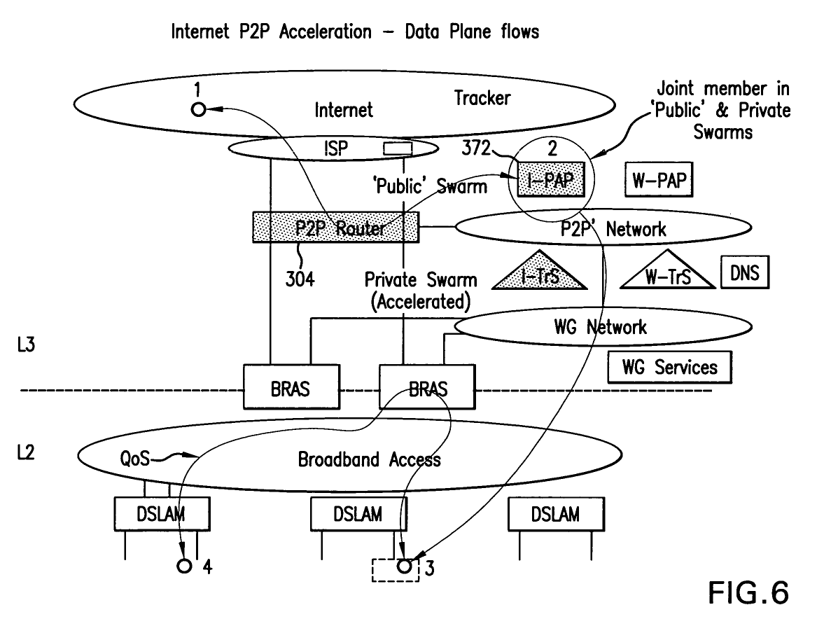

FIGS. 5 and 6 describe a P2P control plane and a P2P data plane, respectively.

Referring now to FIG. 5, FIG. 5 illustrates the accelerated P2P control plane data flow according to one embodiment. As discussed above, I-TrS 374 keeps track of the accelerated P2P peers. Note that I-PAP 372 is a special accelerated P2P peer that is connected to P2P router 304 via high speed links such that it will always get high score from any tracker in the global Internet space.

Note that when a peer client 103 requires a specific chunk from a specific content object (e.g., movie file or other content object), I-PAP 372 will form or be part of the relevant content swarm over the global Internet. In that way, I-PAP 372 will be a joint member of the private swarms and the associated public swarms. Any missing chunk for any private swarm will be known to the I-PAP 372, and, as such, will be downloaded in the fastest way due to the guaranteed high score of the I-PAP 372 in any public swarm. In this manner, the P2P acceleration will be guaranteed for getting the fast completion time. Note that all the accelerated P2P control flows to/from the Internet and between the NSP peers are controlled via P2P router 304.

Referring now to FIG. 6, FIG. 6 illustrates the data plane (P2P Content) flows. For the sake of simplicity, four P2P peers are shown in FIG. 6: (1) a remote Internet peer that contains missing chunks of a particular private swarm; (2) I-PAP 372 that is a joint member of both a private swarm and a public swarm, which public swarm contains the same content needed by the private swarm; (3) a first accelerated P2P peer; and (4) a second accelerated P2P peer that requires the same content object as the first NSP peer.

Once a swarm is created by one of the accelerated P2P peers 3,4 to get a specific content object (p2p clients 3,4 are configured with the I-TrS 374 server address such that all the content requests are forwarded to that I-TrS), I-TrS 374, which behaves as the tracker for that swarm, will indicate to I-PAP 372 all the internet peers containing the missing chunks in the requested object (I-TrS 374 knows which chunks are missing by exchanging updates with Internet trackers 112). I-PAP 372 will search for remote Internet peers that have the missing data and create a public swarm to download the missing chunks. I-PAP 372 is able to find the remote Internet peers that have the missing chunks because I-TrS 374 provides to I-PAP 372 the IP addresses of the Internet peers containing the missing chunks. Once the missing chunks are obtained by I-PAP 372, fast internal acceleration will take place over the P2P pipes from I-PAP 372 to the accelerated P2P peer that created the swarm.

Note that all the accelerated flows traverse through the BRAS 150 by routing the private addresses assigned to the P2P clients (IP Pools assigned for P2P acceleration service, for example: pool per BRAS). The non-accelerated P2P flows will be transparently forwarded to the NSP network by means of public ISP addresses assigned to the non-accelerated peers.

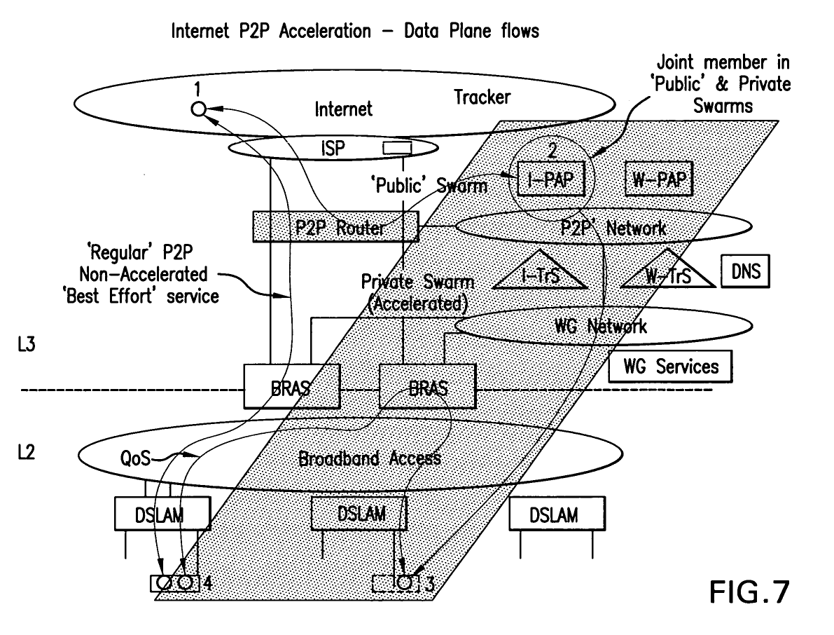

FIG. 7 describes the P2P flows in the NSP network, highlighting the accelerated portion. Note that while the P2P acceleration is taking place in the NSP (utilizing P2P router 304 and the BRAS 150), the non-accelerated flows are routed through the ISP's LNS router over the best-effort pipes (i.e., VC1). Hence, a double acceleration is achieved.

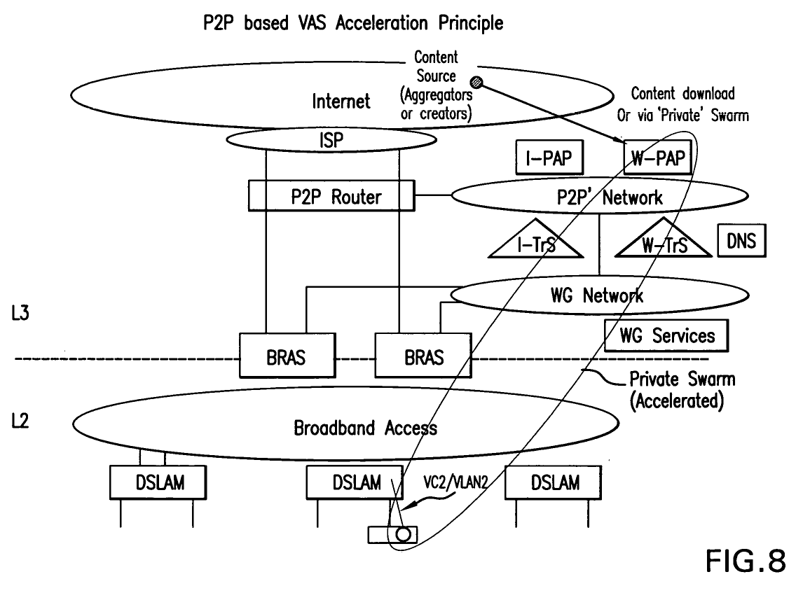

FIG. 8 illustrates that the same P2P acceleration infrastructure used for P2P acceleration services can be used to implement value added services over P2P (VASoP2P).

Any content can be downloaded through the Internet or directly (not necessarily by P2P method). ISP connectivity is not required, and any wholesale agreement can be used. The distribution within NSP network 300 can utilize P2P methods via a P2P peer 103 geared for value added services (the same way Internet content is distributed via P2P), thus, replacing streaming on-demand methods such as unicast VoD that are bandwidth consuming and latency sensitive. By that, the existing broadband bandwidth can be used and better utilized with CapEx and OpEx saving where the CAGR is likely to be higher than 100%.

The NSP can publish through a portal the content that is available as VoD or any other service offering. Any request for content from an accelerated P2P peer will create a private swarm which describes the WG content distributed utilizing P2P (In contrast to Internet P2P acceleration). W-PAP 382 will serve as the initial content distributor to the required content (by P2P peer 103) over NSP network 300. Any further requests will be distributed by P2P methods between the peers controlled by the W-TrS 384.

Two possible enhancements can be provided: The first, using DNS standard methods to redirect the initial content request by P2P peer 103 to the nearest content W-PAP by using URI (Universal Relocation Identifier) (Default DNS programmed within the P2P client software) as a method to get the IP address of the nearest content server W-PAP 382 that contains the requested content. The second accelerate the response time by downloading a preview or the first x minutes of the content and start pushing the content to the client, while in parallel continues downloading the remaining content.

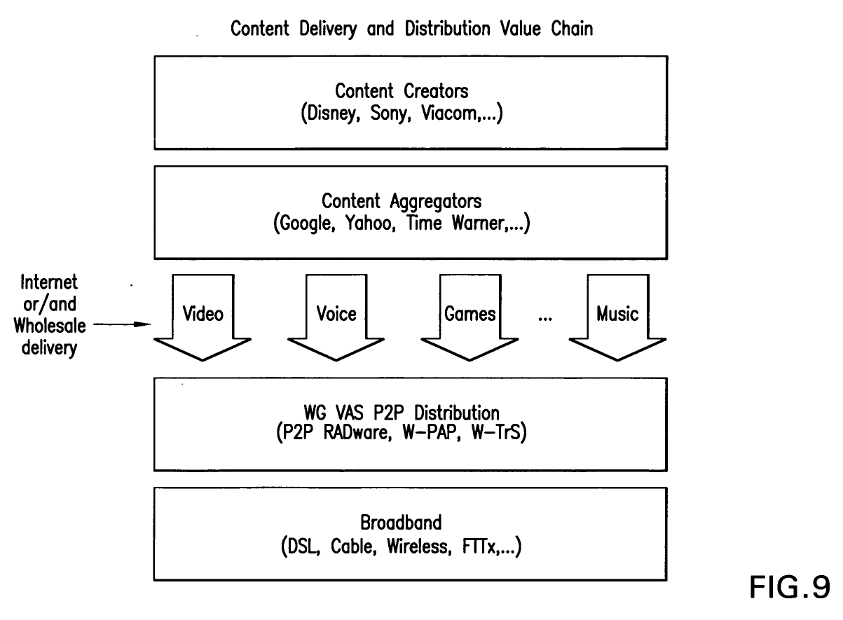

FIG. 9 provides a high level view of the principles associated with the content value chain that enables the NSP to create new business models with content creators/aggregators while providing DRM based accelerated distribution over any broadband access technology utilizing the P2P principles explained.

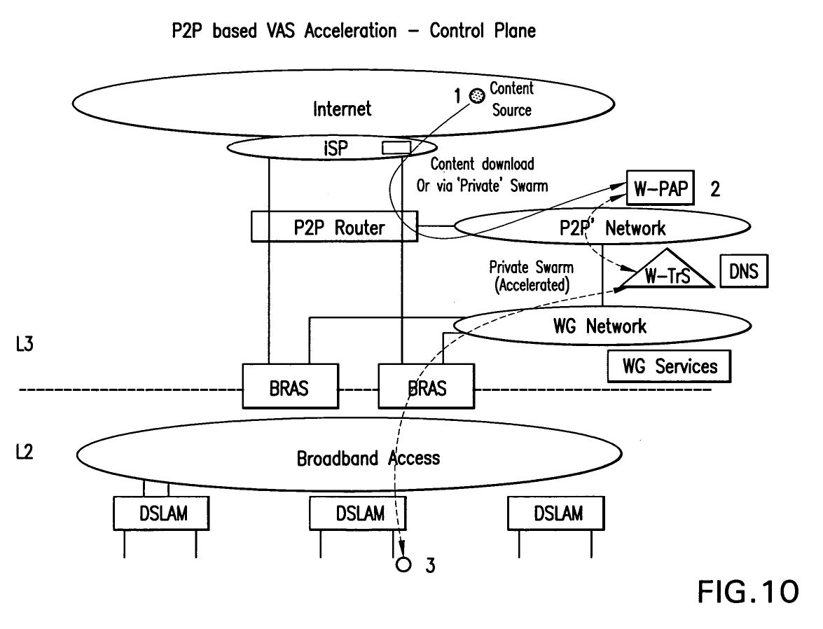

FIG. 10 provides the control plane view of the VASoP2P acceleration principles as described by FIG. 8. W-PAP 382 serves as a content cache or P2P peer with a high score due to high bandwidth connection as in the P2P acceleration model. Note that direct connectivity to the content aggregator's farms can be used (via wholesale or any other means) rather than using P2P distribution model over the Internet as the mean for fast content delivery to the NSP.

Once a request has been made for a specific content (published in the NSP's portal for example) by a P2P peer 103, the W-TrS 384 tracks all the peers containing the requested content and forms the specific swarm (P2P Tracker Server) Fast distribution to user 144 is guaranteed by providing all the IP addresses of the high scored peers containing the missing chunks.

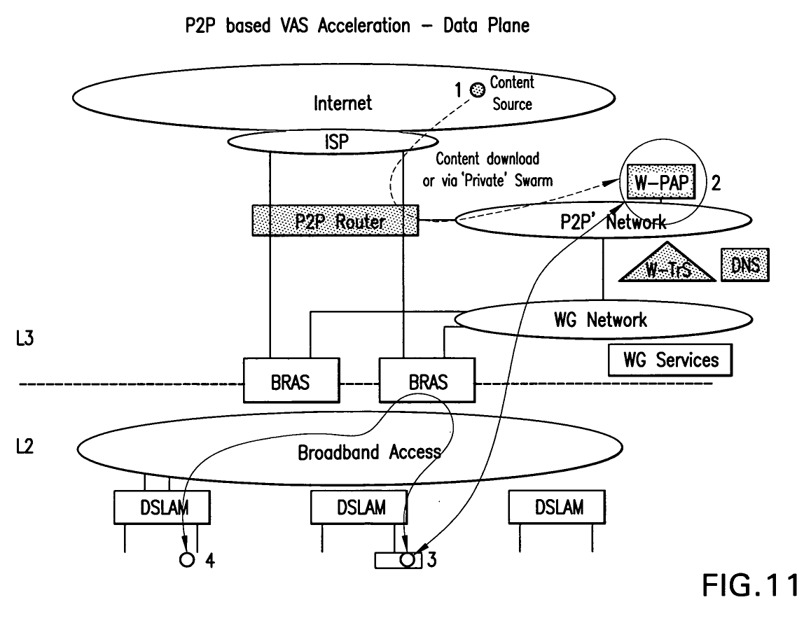

FIG. 11 illustrates the data plane or the data distribution between the peers in a similar way to the Internet P2P distribution explained in FIG. 6. The only change is in the way W-PAP 382 (2) gets the requested content, i.e via wholesale or Internet connectivity from the content aggregators (1). Once the content is obtained by W-PAP 382, the distribution to P2P peers (3,4) is accelerated according to the principles explained throughout this document.

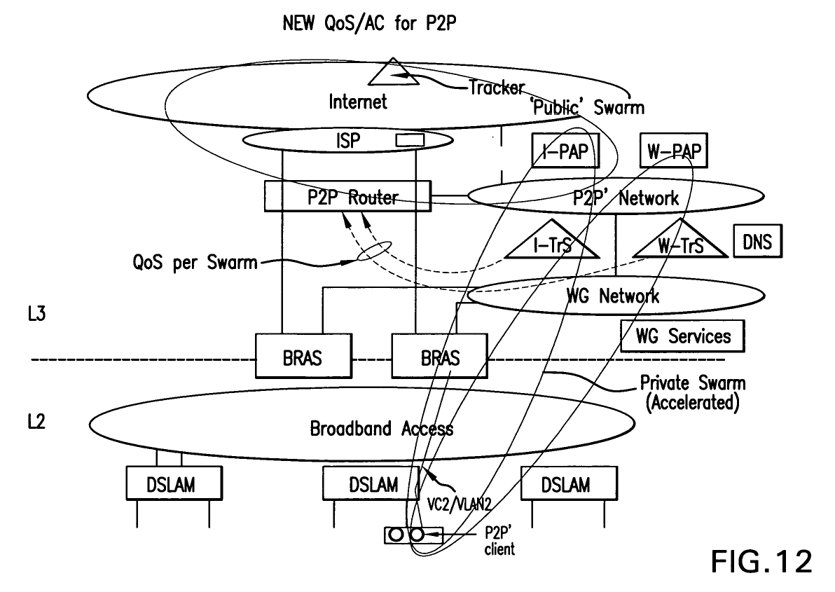

FIG. 12 illustrates enhances to the P2P distribution model, which promotes a new adaptive, self adjustable (self learning) admission control and quality of service model over the NSP access network VC2/VLAN2 pipes. Major engineering savings (CapEx and OpEx) can be achieved by using the P2P distribution model.

The two access swarms shown represent the accelerated internet P2P and walled garden P2P distribution models. Both tracker servers I-TrS and W-TrS maintain (per swarm) the lists of the peers containing the relevant chunks to be transferred according to the seed/leech and up/down available bandwidth, thereby getting real time adaptive self learning distribution model. Thus, the aggregative up/down utilized bandwidth per peer is easily calculated as the sum of concurrent flows to that peer. The calculation can be done by each of the servers or by another device such as the P2P Router 304 as illustrated in FIG. 12. Aggregated P2P admission control and QoS matrices can be provided per peer (SLA reports) and/or BRAS level, rate limiting the edge routers (for example BRAS) trunks from being congested.

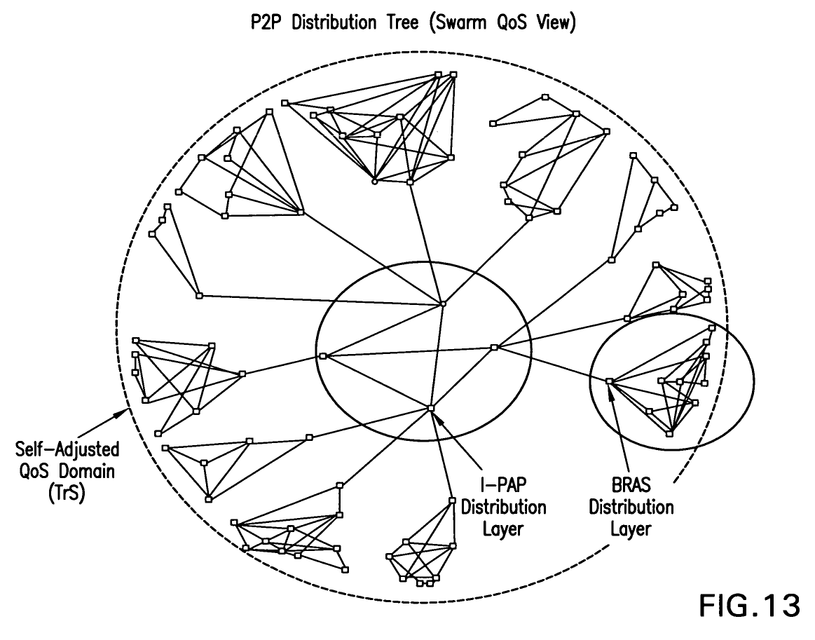

FIG. 13 illustrates a P2P distribution tree. This tree represents a typical swarm distribution graph which is the basis for the adaptive QoS and Admission control (AC) calculation. Note that various methods could be applied and we are not limited as of the implementation method. Note also that each peer endpoint seed/leach ratios are controlled by the TrS as described with reference to FIG. 12

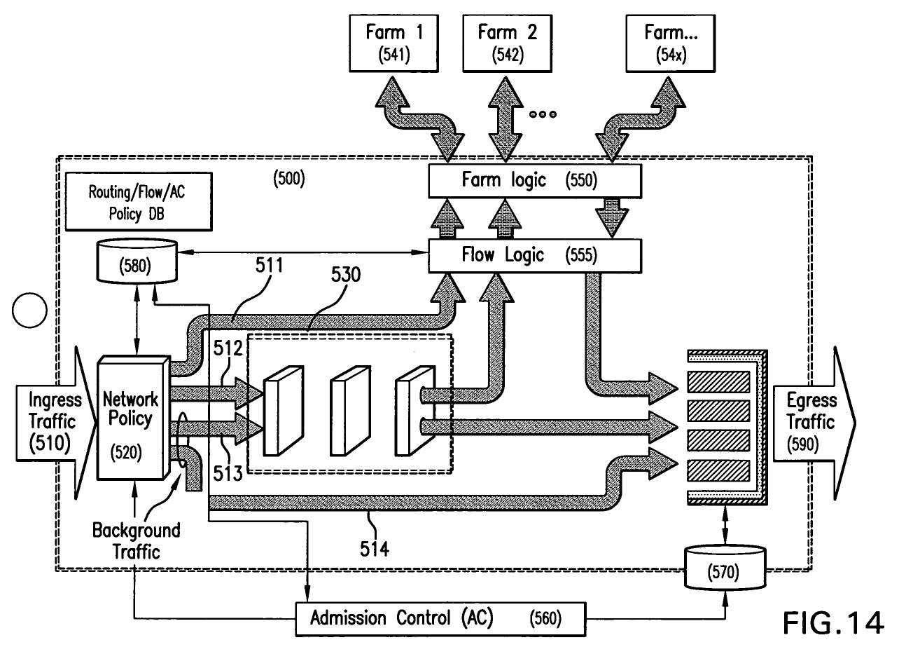

FIG. 14 is a block diagram of P2P Router 304, according to some embodiments of the invention. A top priority in any server-hosting environment is the high availability of the applications themselves. Server load balancing (SLB) provides the key to IP connection load distribution, while simultaneously improving the availability of servers. Scaling out is when multiple servers function as a single logic unit or “farm.” Farms in our implementations would be TrS, I-PAP, W-TrS etc. servers.

Network Policy module 520 classifies the Ingress traffic 510 to four possible flows: 511, 512, 513 and 514.

Flow 511 represents classified P2P traffic to be directed to module flow Logic 555 for additional flow decisions controlled by the Policy Data-Base 580. Flows might be redirected to logical farms 541-54X for a variety of added functionalities (e.g., cryptography, caching, etc . . . ) and forwarded through the bandwidth shaping queues (controlled by policy 570) as egress traffic (590). Policy database 580 provisions the device modules: network policy module 520, admission control (AC) 560 and flow Logic 555. The import provisioning interface might use a variety of existing interfaces to import the details of the registered customers.

Flow 512 represents classified P2P traffic to be directed to options module 530, which impliments in-line functionalities, and the directed to flow Logic 555 for additional flow decisions.

Flow 513 is the same as flow 512 implemented on top of background flows (non P2P), but without the option to redirect to flow logic 555 and farm logic 550 modules. Optionally, non-P2P sessions can be classified by network policy module 520 using the functionalities provided by flow logic 555 and farm logic 550.

Flow 514 represents traffic that gets no treatment besides bandwidth management 570.

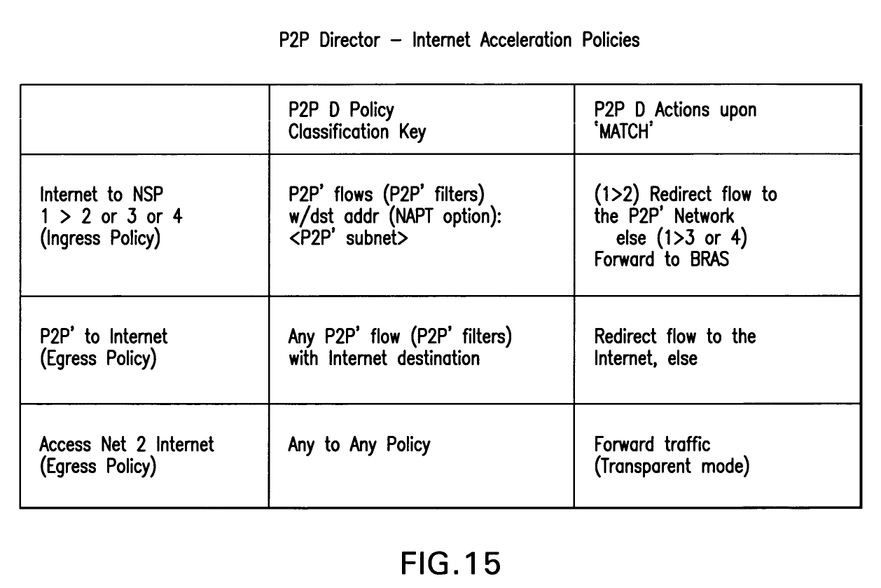

FIG. 15 describes the functional ingress/egress P2P policies preformed by the P2P router 304 according to the peers 1,2,3,4 as described in FIG. 7, representing the peers involved in the control and data planes. The table provides the basic matching key according to L3/4 information (address/ports) with L7 information (P2P signature). The way the wire-speed match can be preformed is not limited by any means and some best/all-fit methods as well as delayed binding methods (for TCP based connections) can be used. In the same way, the basic actions based upon the match are described as follows:

Ingress Policy for P2P′ flows arriving from the internet are identified by the destination address (P2P′ network—keep in mind that for practical security reasons this subnet will be hided to the internet by NAPT function) and the P2P′ signature. In that case the traffic is redirected to the P2P′ network as the initial seed to the swarm, else it is already a part of a other traffic flows and redirected to the access network (through the BRAS)

Egress Policy for P2P′ flows from the P2P′ network are redirected to the internet if the destination address is the internet, else forwarded to the access network

Egress Policies for P2P′ flows that arrive from the access network (peers) are based (upon classification) on any to any policy which means that the P2P router will be transparent and bridge/forward the flows to/from the internet. All the data exchange within internal peers is handled at the BRAS level.

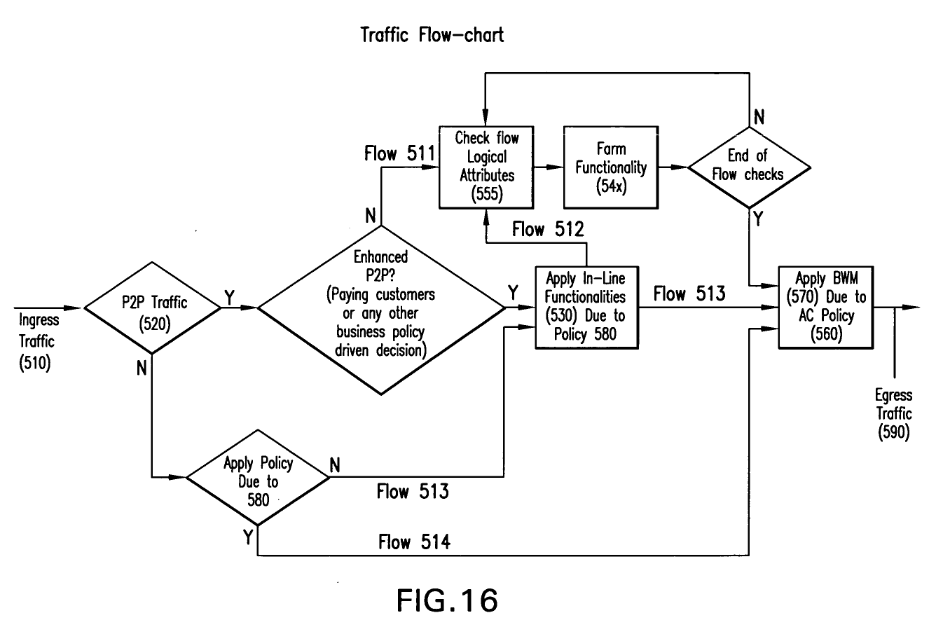

FIG. 16 describes the internal device level logical flows 511-514 as shown in FIG. 14. Upon classification of the ingress flow 510 (match upon L3/4 information AND L7 P2P signature) by network policy module 520 a routing/forwarding decision is made to one of the four possible flows 511-514.

Flows 511-514 are divided to two groups: 511,512 that are classified as P2P flows that should be accelerated (P2P′ client—NSP customer), and flows 513,514 that are classified as background flows (e.g., flows that are bridged and don't get any acceleration treatment). However, the NSP can control all the flows (bandwidth management 570 or other functionalities 530) as explained before (FIG. 14).

Two basic further classifications are made to split the flows individually, which take place under the configured polices 580 controlling the AC 560 and Bandwidth management filters 570.

Both flows 511 and 512 after identification are checked by the flow logic 555 upon specific attributes (L3-7 keys) for redirection to one or more of the farms 541-54x (TrS farm for control flows and I-PAP farms for data flows or any other WG farms). If more complicated flow logic had to be applied, the flow will be once again redirected to another service farm in a cascaded way. In that way we apply a very flexible service model. Finally we apply rate limiting policies 570 on top of all the flows such they can be shaped according to the NSP policies.

While various embodiments/variations of the present invention have been described above, it should be understood that they have been presented by way of example only, and not limitation. Thus, the breadth and scope of the present invention should not be limited by any of the above-described exemplary embodiments.

Additionally, while the processes described above and illustrated in the drawings are shown as a sequence of steps, this was done solely for the sake of illustration. Accordingly, it is contemplated that some steps may be added, some steps may be omitted, and the order of the steps may be re-arranged.

What is claimed is:

1. A method for accelerating peer-to-peer (P2P) traffic, comprising:
providing an access node for enabling a computer connected to the access node to access a network;
creating a first virtual connection between the computer and the access node;
creating a second virtual connection between the computer and the access node;
using the second virtual circuit for accelerating P2P traffic destined for or transmitted from the computer.

2. The method of claim 1, wherein the access node is a multiplexer.

3. The method of claim 1, wherein the multiplexer is a digital subscriber line access multiplexer.

4. The method of claim 1, wherein the second virtual connection is a virtual circuit or a virtual local area network (VLAN).

5. The method of claim 1, wherein the first virtual connection has a first end point routing address that is allocated by a first service provider, and the second virtual connection has a second end point routing address that is allocated by a second service provider.

6. The method of claim 5, wherein the first service provider is an internet service provider and the second service provider is a network service provider.

7. The method of claim 1, further comprising connecting a P2P router between the access node and a public network.

8. The method of claim 7, wherein the public network is the Internet.

9. The method of claim 8, wherein all traffic from the computer to the Internet passes through the P2P router.

10. The method of claim 9, further comprising using the P2P router to create a P2P control plane.

11. The method of claim 10, wherein the P2P control plane provides an automated real-time adaptive quality-of-service plane without the need for traffic engineering.

12. The method of claim 1, further comprising using the second virtual connection to provide a walled garden based distribution service.

13. A system for accelerating peer-to-peer (P2P) traffic, comprising:
a broadband access network;
an access node for providing access to the broadband access network to a user's computer;
a peer-to-peer (P2P) router connected between the broadband access network and a public network; and
a P2P acceleration system, wherein the P2P acceleration system comprises:
a P2P network to which the P2P router is connected,
a peer acceleration proxy server connected to the P2P network, and
a tracker server connected to the P2P network.

14. The system of claim 13, wherein the peer acceleration proxy (PAP) is configured to function as a P2P peer to download missing chunks of data that are sought by the user's computer.

15. The system of claim 14, wherein the PAP is configured to download the missing chunks of data via public swarms over the Internet.

16. The system of claim 15, wherein the tracker server is configured to manage a private swarm.

17. The system of claim 16, further comprising a walled garden acceleration system.

18. The system of claim 17, wherein the walled garden acceleration system comprises:
a walled garden proxy server configured to enable downloading of content from content providers; and
a walled garden tracker server.
